(19) United States
(12) Patent Application Publication
(10) Pub. No.: US 2007/0044662 A1
(43) Pub. Date: Mar. 1, 2007

(54) Method for fabricating dense thin film cermet hydrogen separation membrane

(75) Inventors: Sun-Ju Song, Orland Park, IL (US); Tae H. Lee, Naperville, IL (US); Ling Chen, Woodridge, IL (US); Stephen E. Dorris, LaGrange Park, IL (US); Uthamalingam Balachandran, Hinsdale, IL (US)

Correspondence Address: Harry M. Levy, Esq.;Emrich & Dithmar, LLC, Suite 2080, 125 South Wacker Drive, Chicago, IL, 60606, US

(73) Assignee: The University of Chicago, Chicago, IL (US)

(21) Appl. No.: 11/418,954

(22) Filed: May 5, 2006

Related U.S. Application Data
(60) Provisional application No. 60/711,962, filed on Aug. 25, 2005.
(60) Provisional application No. 60/711,961, filed on Aug. 25, 2005.
(60) Provisional application No. 60/711,963, filed on Aug. 25, 2005.

(51) Int. Cl. B01D 53/22

(52) U.S. Cl. 96/4

(57) ABSTRACT

A method of making a hydrogen permeable in which a colloid suspension of metal powder and ceramic oxide powder dispersed in an organic carrier is contacted with a porous ceramic substrate to deposit a thin film of the colloid suspension on the substrate. The film is then dried and sintered to provide a two part membrane adhered to the porous ceramic substrate. The two part membrane has a metal powder part of one or more of Ni, Pd, Pd alloys, Nb, Ta, Zr, V or mixtures thereof, and an oxide part of one or more of yttria stabilized zirconia, shrinkable alumina, suitably doped cerates, titanates, zirconates of barium or strotium or mixtures thereof, wherein the metal powder part is present in the range of from about 20 to about 80 percent by volume of the two-part membrane.

### RELATED APPLICATIONS

This application, pursuant to 37 C.F.R. 1.78(C), claims priority based on provisional application Ser. Nos. 60/711,962 filed on Aug. 25, 2005, 60/711,961 filed on Aug. 25, 2005, and 60/711,963 filed Aug. 25, 2005.

The object of this invention is to provide dense composite metal and ceramic membranes that can nongalvanically separate hydrogen from other gaseous components and is an improvement to the membranes and methods disclosed in U.S. Pat. No. 6,569,226, the entire disclosure of which is incorporated by reference.

### CONTRACTUAL ORIGIN OF THE INVENTION

The United States Government has rights in this invention pursuant to Contract No. W-31-109-ENG-38 between the U.S. Department of Energy and The University of Chicago representing Argonne National Laboratory.

### FIELD OF THE INVENTION

This invention relates to a membrane and method for extracting hydrogen from fluids and, more particularly, this invention relates to a high-flow rate membrane and an improved method for extracting hydrogen from fluid without using electrical power or circuitry.

### BACKGROUND OF THE INVENTION

Global environmental concerns have ignited research to develop energy generation technologies which have minimal ecological damage. Concerns of global climate change are driving nations to develop electric power generation technologies and transportation technologies which reduce carbon dioxide emissions.

Hydrogen is considered the fuel of choice for both the electric power and transportation industries. While it is likely that renewable energy sources will ultimately be used to generate hydrogen, fossil-based technologies will be utilized to generate hydrogen in the near future.

The need to generate ever larger amounts of hydrogen is clear. Outside of direct coal liquefaction, other major industrial activities, such as petroleum refining, also require hydrogen. Collectively, petroleum refining and the production of ammonia and methanol consume approximately 95 percent of all deliberately manufactured hydrogen in the United States. As crude oil quality deteriorates, and as more stringent restrictions on sulfur, nitrogen and aromatics are imposed, the need for more hydrogen by the refining industry will increase.

Hydrogen production, as a consequence of other processes, is significant. A number of industries requiring hydrogen produce effluents containing significant amounts of unused hydrogen. However, this hydrogen requires clean-up prior to re-use. Furthermore, hydrogen is produced from the gasification of oil, methane, coal, or biomass or other renewable resources, and other petroleum-based materials. However, this hydrogen must be separated from other combustion gases, namely carbon dioxide, in order to be of use.

Petroleum refineries currently use cryogenics, pressure swing adsorption (PSA), and membrane systems for hydrogen recovery. However, each of these technologies has their limitations. For example, because of its high costs, cryogenics generally can be used only in large-scale facilities which can accommodate liquid hydrocarbon recovery. Membrane-based PSA systems require large pressure differentials across membranes during hydrogen diffusion. This calls for initial compression of the feed prior to contact to the upstream side of polymeric membranes and recompression of the permeate to facilitate final purification steps. Not only are these compression steps expensive, but PSA recovers less feedstream hydrogen and is limited to modest temperatures. U.S. Pat. No. 5,447,559 to Rao discloses a multi-phase (i.e. heterogenous) membrane system used in conjunction with PSA sweep gases.

The subject invention is an improvement of the '226 membranes providing higher hydrogen flux than previously obtained and providing an easier method of fabrication of the composite membranes.

### SUMMARY OF THE INVENTION

It is a principal object of the present invention to provide a hydrogen-separation membrane that is an improvement in the membranes of the prior art.

Another object of the present invention is to provide a method of making a hydrogen permeable composition, comprising providing a porous ceramic substrate, forming a colloid suspension of metal powder and ceramic oxide powder dispersed in an organic carrier, dipping the porous ceramic substrate into the colloid suspension to deposit a thin film of the colloid suspension on the substrate, thereafter drying and sintering the thin film to provide a two part membrane adhered to the porous ceramic substrate, the two part membrane having a metal powder part and a ceramic oxide part, the metal powder part being selected from Ni, Pd, Pd alloys, Nb, Ta, Zr, V or mixtures thereof, the oxide part being selected from yttria stabilized zirconia, shrinkable alumina, the cerates, titanates, zirconates of barium or strotium or mixtures thereof, wherein the metal powder part is present in the range of from about 20 to about 80 percent by volume of the membrane.

A final object of the present invention is to provide a method of making a hydrogen permeable composition, comprising providing a porous ceramic substrate, forming a colloid suspension of metal powder and ceramic oxide powder dispersed in an organic carrier, dipping the porous ceramic substrate into the colloid suspension to deposit a thin film of the colloid suspension on the substrate, thereafter drying at ambient temperatures and thereafter sintering the thin film to provide a two part membrane adhered to the porous ceramic substrate, the two part membrane having a metal powder part distributed substantially uniformly throughout and a ceramic oxide part, the metal powder part being selected from Ni , Pd, Pd alloys, Nb, Ta, Zr, V or mixtures thereof, the oxide part being selected from yttria stabilized zirconia, shrinkable alumina, the suitably doped cerates, titanates, zirconates of barium or strotium or mixtures thereof, wherein the metal powder part is present in the range of from about 20 to about 80 percent by volume of the membrane.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1(a) is an SEM illustration of a back scattered electron image of an as-sintered surface of dip coated Ni/BCY thin film on porous Ni/BCY substrate after sintering for 10 h at 1400° C. in 200 ppm H/₂ balance N₂;

FIG. 1(b) is an SEM illustration of a fracture surface of dip-coated Ni/BCY thin film on porous Ni/BCY substrate after sintering for 10 hours at 200 ppm H₂/balance N₂;

### DETAILED DESCRIPTION OF THE INVENTION

Argonne National Laboratory (ANL) is developing two types of novel ceramic membranes for producing pure hydrogen: hydrogen transport membranes (HTMs) and oxygen transport membranes (OTMs), see Table 1. Both types of membrane are dense and produce hydrogen nongalvanically, i.e., they require neither electrodes nor an external power supply. HTMs produce hydrogen by separating it from mixed gases, e.g., product streams generated during coal gasification and/or methane reforming, whereas OTMs generate hydrogen by removing oxygen that is produced during the dissociation of water at moderate temperatures (<about 900° C.).

TABLE 1
ANL Membrane Compositions

| Membrane | Matrix | Metal |
|---|---|---|
| ANL - 0 | BCY | — |
| ANL - 0b | SFC(SrFeCO_{0.5}Oₓ) | — |
| ANL - 0c | SFT(Sr_{1.0}Fe_{0.9}Ti_{0.1}Oₓ) | — |
| ANL - 1a | BCY | Ni |
| ANL - lb | CMO | Ni |
| ANL - lc | TZ-8Y | Ni |
| ANL - 1d | SFT(Sr_{1.0}Fe_{0.9}Ti_{0.1}Oₓ) | Ni |
| ANL - 2a | BCY | Pd |
| ANL - 2b | CMO | Pd/Ag(23 wt. %) |
| ANL - 3a | Al₂0₃ | Pd |
| ANL - 3b | BaTiO₃ | Pd/Ag |
| ANL - 3c | Al₂0₃ | Nb |
| ANL - 3d | A1₂0₃ | Pd/Ag(23 wt. %) |
| ANL - 3e | TZ-3Y | Pd— |
| ANL - 3f | TZ-8Y | Pd |
| ANL - 3g | CaZrO₃ | Pd |
| ANL - 4a | Cu | Nb |

Notes:
BCY = BaCe_{0.8}Y_{0.2}O_{3-δ}
CMO = Ce₁₋ₓMₓO_{2-δ}(M Gd, Y)
TZ-3Y = ZrO₂ (3 mol. % Y₂O₃)
TZ-8Y = ZrO₂ (8 mol. % Y₂O₃)

Because the hydrogen flux through ANL-3e HTMs appears to be limited by the diffusion of hydrogen through the bulk, reducing the membrane thickness is expected to increase the hydrogen flux, or allow the same flux at lower temperatures. To provide better methods of manufacturing ANL membranes, the inventive dip coating process was used for fabricating dense membrane thin films.

This inventive method is dip coating in which the porous substrate was prepared from a mixture of NiO and BCY. The substrate composition was mixed to give 45 vol. % Ni after sintering. To increase the porosity of the substrate, 5 wt. % graphite was added to the NiO/BaCe_{0.8}Y_{0.2}O₃₋₆ (BCY) mixture. The powder mixture was uniaxially pressed into cylindrical disks and then pre-sintered for 5 h at 700° C. in air.

A coating composition was prepared by forming a colloid of a ceramic powder and a metal powder and thereafter dipping a cermet of a ceramic substrate into the colloid, drying and sintering.

Porous substrates were made from either Al₂O₃ or a NiO/TZ-3Y mixture. Two types of Al₂O₃ powder were tested and eliminated from further consideration, because one powder densified completely during sintering, and the other powder did not shrink during sintering. Low shrinkage of the substrate during sintering is a problem, because it hinders densification of the thin film. A third type of Al₂O₃ powder contained about 10 wt. % water, and experienced high shrinkage during sintering of the ANL-3e film that was deposited on it. The high shrinkage of the substrate was considered beneficial to densification of the thin film.

Another type of porous substrate was prepared from a mixture of NiO/TZ3Y mixture whose composition was controlled to give 50 vol. % Ni in the substrate after the NiO was reduced. The powder mixture was milled in isopropyl alcohol for 24 h, then the alcohol was evaporated, and the dried powder was sieved using a 120-mesh sieve. The sieved powder was uniaxially pressed at a pressure of 200 MPa into disks that were partially sintered for 5 h at 900° C. in air. ANL-3e thin films were formed onto partially sintered substrates composed of either Al₂O₃ or NiO/TZ-3Y. The substrates and their ANL-3e films were then sintered in air or in a mixture of N₂ and H₂ either at 1500° C. for 10 h or 1400° C. for 5 h.

Experiment #1: Dense Ni/BCY Film on Porous Ni/BCY Substrate

Composition for Solution

Ni/BaCe_{0.8}Y_{0.2}O_{3.5} 5 gram
Dibutyl phthalate (DBP): 0.3 gram
Solsperse: 0.6 gram
Polyvinyl butyral (PVB): 0.6 gram
Toluene: 1.25 gram
Isopropyl alcohol: 40 ml
Starting particle size of Nickel: average 0.14 μm
Starting particle size of BCY: average 0.5 μm
   Coating Procedure

The colloidal suspension for coating the substrate was prepared by dispersing Ni (40 vol. %) and BCY (60 vol. %) powders in a solution of toluene and isopropyl alcohol that contained polyvinyl butyral (PVB) as a binder, dibutyl phthalate (DBP) as a plasticizer, and a polymeric dispersant. After the colloidal dispersion was mixed on a ball mill for a day, the disk-shaped substrate was horizontally immersed in the colloidal suspension until half of it is inside the suspension. After being held for 10 s, the substrate was pulled up slowly in such a way that the round face of the substrate was completely coated. After the film was dried at room temperature, it was sintered at 1400° C. in 200 ppm H₂/balance N₂ for 10 h. The thickness of the dense cermet films can be adjusted by controlling the dipping and drying steps.

Ni/BCY films made by the dip-coating method were dense, crack-free, and flat. The Ni phase appears to be uniformly distributed.

Experiment #2: Dense Pd/TZ3Y Film on Porous Al₂O₃ Substrate

Composition for Solution

Pd/ 3-mol % Y doped ZrO₂(TZ3Y): 2.5 gram
Dibutyl phthalate (DBP): 0.3 gram
Solsperse: 0.3 gram
Polyvinyl butyral (PVB): 0.3 gram
Toluene: 0 gram
Isopropyl alcohol: 40 ml
Starting particle size of Pd: average 0.1- 5 μm
Starting particle size of TZ3Y: average 0.3 μm
   Coating Procedure

The colloidal suspension for coating the substrate was prepared by dispersing Pd (50 vol. %) and TZ3Y (50 vol. %) powders in a solution of toluene and isopropyl alcohol that contained polyvinyl butyral (PVB) as a binder, dibutyl phthalate (DBP) as a plasticizer, and a polymeric dispersant. The colloidal solution was sonicated for 4 hrs. Other dipping process was as same as experimental #1. After the film was dried at room temperature, it was sintered at 1400° C. in air for 10 h. The thickness of the dense cermet films can be adjusted by controlling the dipping and drying steps.

Pd/TZ3Y films made by the dip-coating method were dense, crack-free, and flat. Pd phase appears to be uniformly distributed.

Sr—Fe—Co—O (SFC) powder for ANL-0b membranes was purchased from Praxair, whereas Sr—Fe—Ti—O (SFT) powder for ANL-1d membranes was prepared at ANL by conventional solid-state reaction between its constituent oxides. To prepare ANL-1d membranes, SFT powder was first mechanically mixed with Ni powder (avg. particle size about 0.1 μm). Powder for ANL-1b membranes was made by reducing a NiO/Ce₁₋ₓGdₓO_{2-δ}(CGO) powder mixture (Praxair) to form Ni/CGO. Disk-shaped membranes were prepared by uniaxially pressing the powders and then sintering the disks in 200 ppm H₂/balance N₂ for 10 h at 1150° C. (ANL-1b), 1200° C. (ANL-0b), and 1350° C. (ANL-1d); however, any of these powder mixtures can be used in a colloid suspension to form membranes by the inventive dip coating method.

A JEOL 5400 scanning electron microscope (SEM) was used to evaluate the microstructure of membranes and to measure their thickness. To prepare OTMs for hydrogen production rate measurements, both sides of sintered disks were polished using 600-grit SiC polishing paper. Thin film HTMs were tested in their as-sintered condition. The procedures for measuring hydrogen permeation and hydrogen production rate are similar, and are known in the art. Unless noted otherwise, hydrogen was used as a model gas to establish a high pO₂ gradient across the membrane for measuring the hydrogen production rate.

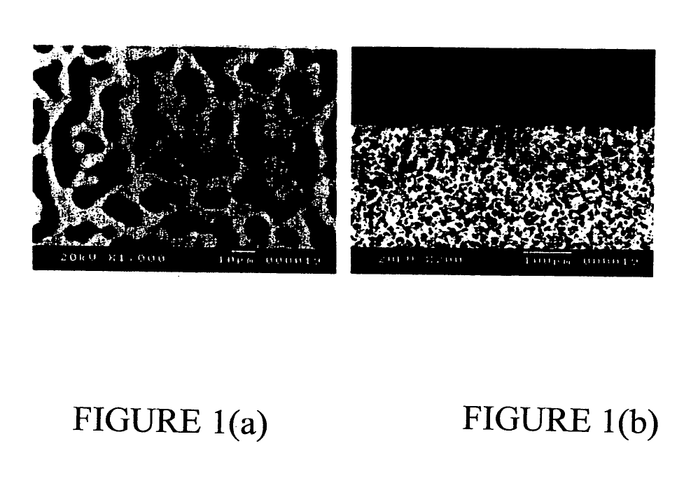

FIG. 1 shows the SEM micrographs of a back scattered electron image of an as-sintered surface of dip coated Ni/BCY thin film on porous Ni/BCY substrate after sintering for 10 h at 1400° C. in 200 ppm H/₂ balance N₂. The film thickness can be easily controlled by adjusting number of paste painting.

In general thicknesses between 5 and 50 microns can be made with the inventive process, but thinner films improve hydrogen flux, so films less than about 20 microns are preferred and films about 10 microns thick are not preferred.

The inventive dip coating paste method is applicable for preparing thin 5-50 micron membranes for both HTM and OTM species. For HTM membranes the metal powder used in the two part HTM membranes preferably has an average diameter in the range of from about 0.1 to about 5 microns and more preferably in the range of from about 1 to about 3 microns and most preferably an average diameter of about 2 microns. The ceramic powder used in the two part HTM membranes preferably has an average diameter in the range of from about 0.1 to about 1 micron and preferably from about 0.3 to about 0.8 microns. The hydrogen transfer membranes are preferably 96% of theoretical density and most preferably about 98% of theoretical density. The thickness of the membranes, as before stated is about 5 to 50 microns, preferably 5 to 20 microns and most preferably about 10 microns, it being understood that thinner is better due to the improved hydrogen flux through the membrane for thinner membranes.

An important feature of the present invention is that with the dip coating, it is possible to provide two different materials that have coefficients of expansion which are relatively close, it being preferred that the coefficience for the expansion of the membrane be less than about 10% difference. In some cases, the porous ceramic substrate and the ceramic oxide portion of the membrane may be the same or substantially the same. While there are a variety of metals which are useful as the metal powder part of a two part hydrogen permeable membrane such as Ni, Pd, Pd alloys, Nb, Ta, Zr, V or various mixtures thereof, the preferred metal is Pd or a Pd-Ag alloy or mixture thereof. Moreover, the ceramic portion of the two-part membrane may be a variety of materials, for instance yttria stabilized zirconia, shrinkable alumina, the cerates or titanate, zirconates of barium or strontium and mixtures thereof but the preferred oxide is the yttria stabilized zirconia. Where alumina is used, the alumina should be capable of shrinking upon sintering in air and to this end, a alumina with about 10% water has been found particularly satisfactory. It has been found that the hydrogen flux through the membranes made by paste painting is improved or can be improved by varying the heat treatment of the membrane. For instance, after the paste has been applied, the membranes can be heated at a variety of temperatures generally above 1000° C. As previously discussed, membranes which have been heated to 1400° C. for a period of time and thereafter at 1500° C. seem to have an improved flux. This treatment may hold true for the dip coated membranes.

It is believed that the method of producing hydrogen transfer membranes according to the dip coating inventive method produces superior hydrogen transport where the metal powder in the two-part membrane is present in the range from about 20 to about 80% by volume. Obviously, the greater the hydrogen concentration gradient across the membrane the more improved the flux will be for a given temperature pressure and other conditions.

Also as disclosed herein, improved oxygen permeable membranes may be prepared by the inventive dip coating method utilizing those compounds previously identified as water splitting compounds in U.S. Pat. No. 6,726,893 issued Apr. 27, 2004, the entire disclosure of which is herein incorporated by reference. The oxygen transfer membranes operate by splitting water comes in contact with the surface of the membrane and is disassociated into hydrogen atoms and oxygen atoms with the oxygen atoms passing through the membrane leaving the hydrogen atoms on the original side. As is well known, thermodynamics insures that water splitting continues under these circumstances and both one part or two part membranes are capable of being manufactured by the method herein described. For a one-part membrane, the oxygen permeable composition is one or a mixture of Sr(Fe_{1-y}Co_{y})Oₓ or Sr(Fe1-yTi_{y})Oₓ. The oxygen permeable composition may also be formed of a two part membrane in which a metal powder part is selected from Ni, Ag, or Fe or alloys or mixtures thereof with Ni being preferred while the oxide part may be selected from CeO₂ doped with lower valence atoms, Gd being preferred or Zr being suitably doped with a lower valence atoms usually from the lanthanides, or a SrFeCo_{0.5}Oₓ or various mixtures thereof. Doping of these materials is within the skill of the art. These membranes can be made very thin, also less than about 20 microns and preferably less than about 10 microns and exhibit good if not superior oxygen permeability.

While the invention has been particularly shown and described with reference to a preferred embodiment hereof, it will be understood by those skilled in the art that several changes in form and detail may be made without departing from the spirit and scope of the invention.

The embodiments of the invention in which an exclusive property or privilege is claimed are defined as follows:

1. A method of making a hydrogen permeable composition, comprising
providing a porous ceramic substrate,
forming a colloid suspension of metal powder and ceramic oxide powder dispersed in an organic carrier,
dipping the porous ceramic substrate into the colloid suspension to deposit a thin film of the colloid suspension on the substrate,
thereafter drying and sintering the thin film to provide a two part membrane adhered to the porous ceramic substrate,
the two part membrane having a metal powder part and a ceramic oxide part, the metal powder part being selected from Ni, Pd, Pd alloys, Nb, Ta, Zr, V or mixtures thereof,
the oxide part being selected from yttria stabilized zirconia, shrinkable alumina, suitably doped cerates, titanates, zirconates of barium or strotium or mixtures thereof, wherein the metal powder part is present in the range of from about 20 to about 80 percent by volume of the two-part membrane.

2. The method of claim 1, wherein the organic carrier includes an organic binder and/or an organic dispersant and/or an organic plasticizer.

3. The method of claim 1, wherein the organic carrier is present in the colloid suspension in the range of from about 97 volume percent to about 99.8 volume percent.

4. The method of claim 1, wherein the metal powder is present in the colloid suspension in the range of from about 0.1 volume percent to about 1 volume percent.

5. The method of claim 1, wherein the ceramic powder is present in the colloid in the range of from about 0.1 volume percent to about 2 volume percent.

6. The method of claim 1, wherein the sintering occurs at a temperature above about 1400° C.

7. The method of claim 1, wherein the dipping and drying steps are repeated to form a membrane having a desired thickness.

8. The method of claim 1, wherein the organic carrier includes toluene and isopropyl alcohol.

9. The method of claim 1, wherein the metal powder is Ni or Pd.

10. The method of claim 1, wherein the ceramic oxide powder is a suitably doped barium-cerium-yttrium oxide (BCY) or yttria stabilized zirconia (YSZ).

11. The method of claim 1, wherein the powders in the colloid are Ni and suitably doped BCY.

12. The method of claim 1, wherein the powders in the colloid are Pd and YSZ.

13. The method of claim 1, wherein the metal powder in the colloid suspension is about 0.65 volume percent and the ceramic powder in the colloid suspension is about 0.85 volume percent.

14. A method of making a hydrogen permeable composition, comprising providing a porous ceramic substrate,
forming a colloid suspension of metal powder and ceramic oxide powder dispersed in an organic carrier,
dipping the porous ceramic substrate into the colloid suspension to deposit a thin film of the colloid suspension on the substrate,
thereafter drying at ambient temperatures and thereafter sintering the thin film to provide a two part membrane adhered to the porous ceramic substrate,
the two part membrane having a metal powder part distributed substantially uniformly throughout and a ceramic oxide part,
the metal powder part being selected from Ni, Pd, Pd alloys, Nb, Ta, Zr, V or mixtures thereof,
the oxide part being selected from yttria stabilized zirconia , shrinkable alumina, the suitably doped cerates, titanates, zirconates of barium or strotium or mixtures thereof,
wherein the metal powder part is present in the range of from about 20 to about 80 percent by volume of the two-part membrane.

15. The method of claim 14, wherein the colloid is formed by sonication.

16. The method of claim 14, wherein sintering occurs in an atmosphere containing hydrogen and nitrogen.

17. The method of claim 14, wherein the metal powder forming the colloid has average diameters in the range of from about 0.1 to about 5 microns.

18. The method of claim 14, wherein the ceramic powder forming the colloid has average diameters in the range of from about 0.1 to about 1 micron.

19. The method of claim 14, wherein the metal and ceramic powders are ball milled before the colloid is formed.
